(19) United States
(12) Patent Application Publication
(10) Pub. No.: US 2009/0032442 A1
(43) Pub. Date: Feb. 5, 2009

(54) Municipal solid waste sorting system and method

(75) Inventors: Naveen David Singh, New South Wales (AU); Rodney Gerald France, Western Australia (AU); Lance James Sambell, Western Australia (AU); Patrick Thomas Poelzer, Edmonton (CA)

Correspondence Address: KNOBBE MARTENS OLSON & BEAR LLP, 2040 MAIN STREET, FOURTEENTH FLOOR, IRVINE, CA, 92614, US

(73) Assignee: GRL Investments Pty Limited, Melbourne, Victoria (AU)

(21) Appl. No.: 11/628,813

(22) PCT Filed: Jun. 9, 2004
(86) PCT No.: PCT/AU2004/000763

§ 371 Date: Nov. 26, 2007

(51) Int. Cl. B07B 15/00; B07B 13/04

(52) U.S. Cl. 209/12.1

(57) ABSTRACT

A method, and associated system, of sorting municipal solid waste (120) into types of materials, the method including the steps of: sorting the solid waste (120) into an oversize fraction (180), a midsize fraction (170) and an undersize fraction (160); using at least manual-based (210, 330), density-based (234, 310), further size-based (346) and metal-based (318) sorting means to obtain a partial oversize fraction (236), a first partial midsize fraction (348) and a second partial midsize fraction (350); combining the partial oversize fraction (236) and the first partial midsize fraction (348) to produce an oversize-midsize combined fraction (237), and combining the undersize fraction (160) and the second partial midsize fraction (350) to produce an undersize-midsize combined fraction (412); and, using further sorting means to further sort the oversize-midsize combined fraction (237) and the undersize-mid-size combined fraction (412) into types of materials.

### TECHNICAL FIELD

The present invention relates to a system and method for sorting solid waste material, and in particular, to a system and method for sorting municipal solid waste that enhances the recovery of recyclable, reusable or otherwise useful resources from the municipal solid waste materials.

### BACKGROUND ART

Municipal solid waste (“MSW”) (i.e municipal solid waste materials, bagged or not) has traditionally posed problems for disposal. Difficulties have become increasingly critical as populations have expanded and as the per capita production of solid waste has increased. Municipal solid waste typically includes components which are worthwhile to reclaim. For example, resources such as organic matter, glass, metals, plastics, paper components, etc., are sufficiently valuable, in both an economical and environmental sense, to justify their separation from composite MSW.

In the past, MSW has been disposed of by incineration and/or as landfill. With present concerns over problems associated with the protection of the environment and because of scarcity of landfill space and governmental regulations, both of these traditional techniques of disposal are no longer desirable.

Recycling and resource recovery activities reduce the volume of waste directed to landfill and increase the amount of materials recovered for reuse or reprocessing. In order to be effective, MSW must be sorted or separated into different types of materials, generally termed fractions, that can then be further processed according to recycling or resource recovery techniques applicable to each type of fraction material. A variety of mechanical, biological and thermal technologies provide the means to achieve recovery of resources by recycling or resource of the materials in sorted fractions.

For example, if biological matter can be effectively separated in composite or mixed MSW then processes such as aerobic, anaerobic, fermentation, conversion to a biomass fuel or vermiculture based treatment can make good use of the otherwise wasted biological matter, such as producing composts or facilitating renewable energy production. A diverse range of other technologies can likewise make good use of other types of separated materials.

However, in order to take advantage of the benefits of recycling or reuse technologies the MSW must be effectively and efficiently sorted. Cross-contamination of types of materials in different fractions during the sorting stage can affect the effectiveness of recycling or reuse technologies. It is important, for both efficiency and cost-effectiveness of subsequent recycling or reuse processing, that the initial sorting process is itself efficient and accurate. The initial sorting process has posed a variety of problems in this regard.

Sorting systems or methods, to remain efficient, should be capable of a reasonably high throughput rate whilst still effectively (viz. relatively accurately) sorting resources from the MSW into fractions with reduced or minimal cross-contamination. The initial sorting process is complicated by the wide variety of materials forming typical MSW. Also, MSW varies significantly in daily composition, thus a uniform conglomerated or composite municipal waste material is not available for initial sorting or separation.

Some separation or sorting techniques are presently known. Recently, the trend has been to provide materials-recovery facilities which are generally established in large plants that attempt to process large amounts of comingled recyclable material. Manual techniques which rely solely on human sorters are generally not regarded as cost effective or desirable. An example is a system that uses a conveyor to feed MSW past a multiplicity of sorting stations located along the conveyor, whereby a limited number of waste material types are individually extracted by human sorters. Residual MSW is then sent to a landfill. Automatic techniques which rely on fraction sizes, i.e. physical dimensions, of MSW, electromagnetic or magnetic properties of a fraction, or the density of a fraction, have generally not been successfully employed by industry in an efficient and effective manner.

Achieving high quality sorting within reasonable cost limits is a problem inherent in the prior art which proves difficult to solve. Various problems and difficulties are encountered in providing a suitable means of separating MSW in a relatively quick and accurate manner so as to establish a cost effective system or method of retrieving recyclable materials.

This identifies a need for a municipal solid waste sorting system or method which overcomes or at least ameliorates problems inherent in the prior art.

### DISCLOSURE OF INVENTION

In a first broad form the present invention provides a method of sorting municipal solid waste into types of materials, the method including the steps of: sorting the solid waste into an oversize fraction, a midsize fraction and an undersize fraction using a size-based sorting means; using at least manual-based, density-based, further size-based and metal-based sorting means to obtain a partial oversize fraction, a first partial midsize fraction and a second partial midsize fraction; combining the partial oversize fraction and the first partial midsize fraction to produce an oversize-midsize combined fraction, and combining the undersize fraction and the second partial midsize fraction to produce an undersize-midsize combined fraction; and, using further manual-based, density-based, size-based or metal-based sorting means to further sort the oversize-midsize combined fraction and the undersize-midsize combined fraction into types of materials.

In particular non-limiting forms, the partial oversize fraction is the residue of manual-based extraction and subsequent density-based extraction, and, the first partial midsize fraction and the second partial midsize fraction are the residues of density-based extraction, and then metal-based extraction, and then manual-based extraction and then size-based sorting.

In a second broad form the present invention provides a system for sorting municipal solid waste into types of materials, the system including: a size-based sorting means for sorting the solid waste into an oversize fraction, a midsize fraction and an undersize fraction; manual-based, density-based, further size-based and metal-based sorting means to obtain a partial oversize fraction, a first partial midsize fraction and a second partial midsize fraction; means to combine the partial oversize fraction and the first partial midsize fraction to produce an oversize-midsize combined fraction, and means to combine the undersize fraction and the second partial midsize fraction to produce an undersize-midsize combined fraction; and, further manual-based, density-based, size-based or metal-based sorting means to further sort the oversize-midsize combined fraction and the undersize-midsize combined fraction into types of materials.

In particular non-limiting forms, the automatic size-based sorting means are trommels, the manual sorting stations are provided with chutes to facilitate extraction of types of materials, the density-based sorting means are windsifters or bounce adherence conveyors, the metal-based sorting means are magnetic separators or non-ferrous metal separators provided individually or in combination, the magnetic separators are rotary belt magnetic separators, and/or the metal-based sorting means utilise magnetic, electromagnetic, conductivity or insulating properties of materials. Furthermore, there can be provided a products baler to package extracted types of materials.

According to an alternate embodiment of the invention, one or more of the manual sorting stations can be replaced by appropriate automated systems adapted to perform the required sorting.

### BRIEF DESCRIPTION OF FIGURES

The present invention should become apparent from the following description, which is given by way of example only, of a preferred but non-limiting embodiment thereof, described in connection with the accompanying figures.

FIG. 1 illustrates a process flow diagram of initial fraction sorting according to an embodiment of the invention;

FIG. 2 illustrates a process flow diagram of subsequent oversize fraction sorting according to an embodiment of the invention;

FIG. 3 illustrates a process flow diagram of subsequent midsize fraction sorting according to an embodiment of the invention;

FIG. 4 illustrates a process flow diagram of subsequent undersize fraction sorting according to an embodiment of the invention.

### MODES FOR CARRYING OUT THE INVENTION

The following modes are described in order to provide a more precise understanding of the subject matter of the present invention. In the figures, incorporated to illustrate the features of the present invention, like reference numerals are used to identify like parts throughout the figures.

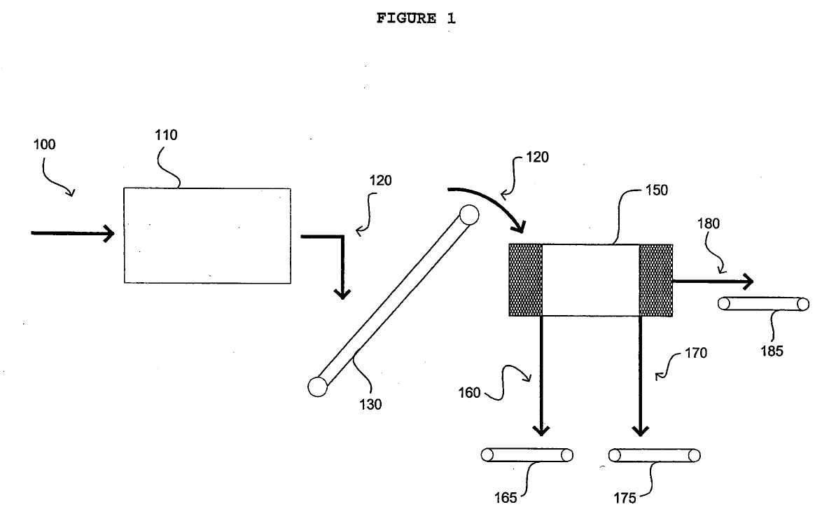

Referring to FIG. 1, there is illustrated a flow chart for sorting municipal solid waste into types of materials. MSW can be delivered to a facility housing the system of the present invention by a variety of means, for example by delivery trucks. A receiving hall may be provided to cater for delivery trucks that can deposit MSW into a designated area so that the MSW can then be removed, for example by front-end loader, away from a tipping floor to a designated area. Bins or skips can be provided for bulky rejects and hazardous material in the receiving hall.

MSW (100) is loaded, for example by front-end loader, into a feed hopper of a bag opener (110), for example an SCT model Splitter-3, which is provided with a set of three augers in one single reinforced sheet housing. Bag opener (110) is designed to split and tear bags containing bagged solid waste (100) without causing significant damage to the recyclable or reusable materials contained within.

The solid waste (120) discharged from bag opener (110) is fed or deposited onto conveyor (130) and directed to first automatic size-based sorting means (150). In a particular embodiment, first automatic size-based sorting means (150) is a scalping trommel. A weightometer can be provided to measure trommel (150) input.

First automatic size-based sorting means sorts the solid waste (120) into an undersize fraction (160), a midsize fraction (170) and an oversize fraction (180). In a particular embodiment, first automatic size-based sorting means (150) is fitted with two screen panel zones with apertures determined by waste characterisation. Three size fractions can be produced, the undersize fraction (160) (for example, less than 50 mm) consisting mainly of organic-rich materials, the midsize fraction (170) (for example, greater than 50 mm but less than 200 mm) containing most of the hard recyclables, and the oversize fraction (180) containing mostly bulky recyclables and rejects. Undersize fraction (160) is passed onto undersize conveyor (165) for transportation to a designated area, midsize fraction (170) is passed onto midsize conveyor (175) for transportation to a designated area, and oversize fraction (180) is passed onto oversized conveyor (185) for transportation to the relevant oversize fraction designated area.

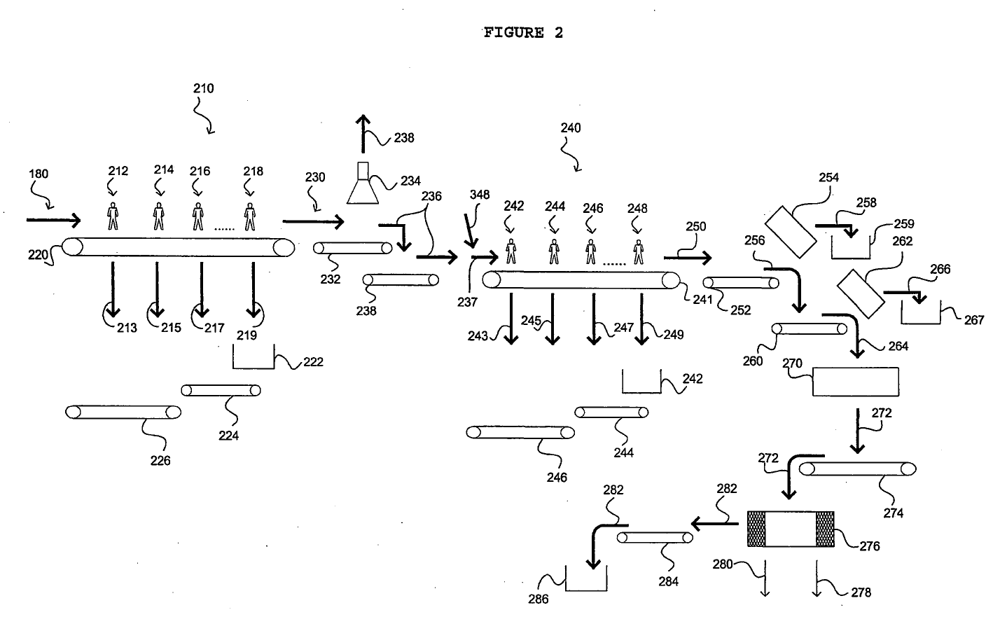

Referring to FIG. 2 the oversize fraction (180) is transported on conveyor (220) passed a first manual sorting station (210). First manual sorting station (210) consists of a number of human sorters (212, 214, 216 and 218). Although only four human sorters are illustrated it should be realised that any number of human sorters can be provided. Oversize fraction (180) discharges onto the relatively slow moving, purpose designed hand-sorting conveyor belt (220) which is preferably, but not necessarily, enclosed in a fully ventilated, air-conditioned, hand-sorting cabin or cabins. A series of hand-sorting stations can be provided within the extent of general first manual sorting station (210) so that human sorters can remove particular waste material of interest from oversize fraction (180). For example, individual human sorters (212, 214, 216 and 218) can be directed to remove bulky green waste, film plastic, other bulky rejects, large cardboard and/or paper recyclable materials, or any other types of materials. Associated chutes can be provided for extracted material (213, 215, 217 and 219) so that different types of extracted materials are directed to different bins, compactors, conveyors, areas or locations. For example, this may be achieved by extracted material (213, 215, 217 or 219) being directed to a bin (222), or conveyors (224 or 226). Conveyors (224 or 226) may redirect materials to other bins which, together with bin (222), may be storage bunkers or directed to baling machines for compaction of the extracted materials.

Material that remains after first manual sorting station (210), being the residue (230) of first manual sorting station (210), is transported by conveyor (232), or a series of conveyors, past first density-based sorting means (234). In a specific example, first density-based sorting means (234) is a windsifter adapted for the removal of film plastic. The first density-based sorting means (234) sorts residue materials (230) into a first oversized fraction (238), for example consisting mainly of film plastic, and a second oversize fraction (236) that is discharged onto conveyor (238).

Second oversize fraction (236) is combined with sixth midsize fraction (348) (to be described in further detail hereinafter), to form oversize-midsize combined fraction (237) that is deposited on conveyor (241) of a third manual sorting station (240). Similar to the first manual sorting station (210), described hereinbefore, the third manual sorting station (240) includes a number of human sorters (242, 244, 246 and 248) that are instructed to extract specific materials from the oversize-midsize combined fraction (237) that is being transported before them on conveyor (241). Extracted material (243, 245, 247 and 249) can be removed and passed down chutes to receiving bin (242) or conveyors (244 or 246), similar to the arrangement hereinbefore described. Also as hereinbefore described, any number or configuration of human sorters, chutes for extracted material, bins or conveyors can be provided depending on the number and types of materials to be extracted at third manual sorting station (240).

Third manual sorting station (240), according to a preferred, but non-limiting, embodiment includes a series of hand-sorting stations for the removal of cardboard, paper, coloured and clear PET, and/or opaque and coloured HDPE plastic containers. These recyclables can be dropped through chutes into bins, storage bunkers, etc., or onto conveyors as previously described.

Waste material remaining after third manual sorting station (240) progresses as residue (250) of third manual sorting station (240). Residue (250) is transported by conveyor (252), either above, underneath or through, second metal-based sorting means (254 and/or 262). Second metal-based sorting means (254 and/or 262) can be provided by a a single or a plurality of individual metal sorting means, provided as a single unit, in series or in parallel, depending on the types of metal to be sorted or extracted.

In a particular but non-limiting embodiment, residue (250) passes ferrous metal sorting means (254) that extracts a metallic-rich fraction (258) that can be deposited or transported to bin (259). Fraction (256) may then be deposited onto conveyor (260) so that remaining material passes by non-ferrous metal sorting means (262) which extracts a further metallic-rich fraction (266) that is deposited or transported to bin (267), thereby leaving first oversize-midsize combined fraction (264) after the second metal-based sorting means (254 and/or 262) has been applied to residue (250). Metallic-rich fractions (258 and 266) are herein referred to as the second oversize-midsize combined fraction (258 and 266).

In a specific embodiment, ferrous metal sorting means (254) may be a rotary belt magnetic separator, and non-ferrous metal sorting means (262) may be one of a variety of types of non-ferrous metal separator apparatus.

In a further particular embodiment of the present invention the first oversize-midsize combined fraction (264) can be passed into shredder (270) to produce shredded combined fraction (272) which is then deposited onto conveyor (274) to be transported to a third automatic size-based sorting means (276), which for example may be a trommel. Any desired size of apertures can be utilised in the trommel. Third automatic size-based sorting means (276) produces an undersize fraction being a fifth oversize-midsize combined fraction (278), a midsize fraction being a fourth oversize-midsize combined fraction (280), and an oversize fraction being a third oversize-midsize combined fraction (282). Undersize and midsize fractions (278 and 280) are normally organic-rich. Oversize fraction (282) can be passed onto conveyor (284) to be deposited in bin (286), holding region, truck, etc., to be removed as landfill.

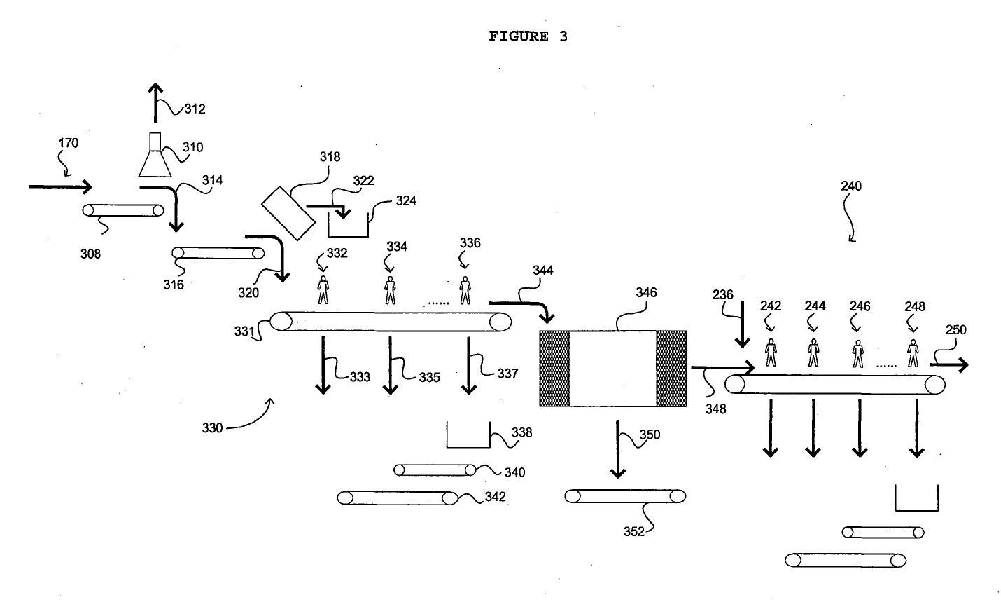

Referring to FIG. 3, midsize fraction (170) is deposited onto conveyor (308) and transported past second density-based sorting means (310), which for example can be a further windsifter. Second density-based sorting means (310) sorts midsize fraction (170) into a first midsize fraction (312) of lighter density material, for example film plastics, and a second midsize fraction (314) which is deposited onto conveyor (316).

Conveyor (316) transports second midsize fraction (314) past first metal-based sorting means (318), which for example may be a rotary belt magnetic separator or any other type of device that can be used to extract metals, or materials with metallic properties, for example by utilising magnetic, electromagnetic, conductivity or insulating properties of materials in the second midsize fraction (314). First metal-based sorting means (318), which may be a series of devices although only a single device is illustrated, extracts third midsize fraction (322), being a metallic-rich fraction, that is deposited in or transported to bin (324). The remainder of second midsize fraction (314), being fourth midsize fraction (320) is deposited onto conveyor (331) forming part of second manual sorting station (330).

As has been described hereinbefore, second manual sorting station (330) includes human sorters (332, 334 and 336) and chutes associated with extracted material (333, 335 and 337). Also provided can be bins (338) or conveyors (340 and 342). In a specific embodiment, second manual sorting station (330) is a glass hand sorting station in which clear glass, brown glass and green glass is extracted from the fourth midsize fraction (320).

The residue (344) of second manual sorting station (330) is deposited into second automatic sized-based sorting means (346), which in a specific embodiment is an organic removal trommel. The undersize fraction, being the fifth midsize fraction (350) is sorted and deposited onto conveyor (352). The fifth midsize fraction (350) obtained from the second automatic size-based sorting means (346) is expected to be composed of organic-rich materials. The oversize fraction, being the sixth midsize fraction (348) is combined with the second oversized fraction (236) and introduced to the third manual sorting station (240), which has been hereinbefore described as have the subsequent sorting steps.

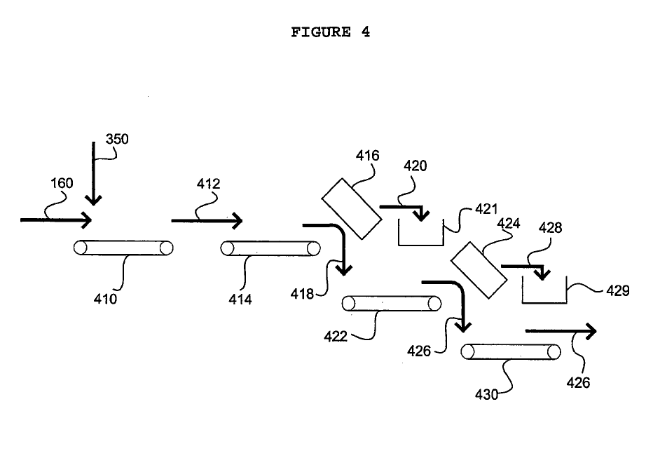

Referring to FIG. 4, the undersize fraction (160) is combined with the fifth midsize fraction (350) produced from the second automatic size-based sorting means (346). These fractions are deposited on conveyor (410) as, or to be, undersize-midsize combined fraction (412), which is transported by conveyor (414) past third metal-based sorting means (416 and/or 424). Metallic-rich fractions (420 and 428) are obtained from third metal-based sorting means (416 and 424) as has been previously described in reference to metal-based sorting means (254 and/or 262). Metallic-rich fractions (420 and 428), herein collectively termed first undersize-midsize combined fraction (420 and 428), can be deposited in or transported to bins (421 and 429), respectively, depending on whether the fractions are ferrous or non-ferrous metallic-rich. However, any number of third metal-based sorting means (416 and/or 424) can be provided, not being limited to two metal-based sorting means as illustrated.

Subsequent to the third metal-based sorting means (416 and/or 424) a residual second undersize-midsize combined fraction (426) is deposited onto conveyor (430) to be transported to a designated area. Second undersize-midsize combined fraction (426) is expected to be an organic-rich fraction that can be transported for further biological or organic-based processing.

In various forms of the invention the various metal-based sorting means could be types of electrostatic particle separators, triboelectric separators, high tension roll separators, or the like, which can be provided individually or in combination as series or parallel elements.

Furthermore, it should be appreciated that additional conveyors, or other transportation devices suitable for waste materials, but not illustrated, can be provided to facilitate transportation of various waste materials or fractions between stations, machines, bins, compactors, storage areas, conveyors and/or other designated areas.

In a further embodiment of the present invention the sorted recyclable or reusable materials, for example cardboards, paper, HDPE and/or PET plastics, etc., can be directed to a baler feed conveyor (not illustrated) which feeds the materials into a baler machine (not illustrated). Each type of material can than be pressed into bales and stored in readiness for transport to recyclables markets.

It should also be appreciated that a wide variety of parameters can be employed in various embodiments of the present invention. For example, size-based sorting means can sort waste materials based on a variety of size settings. Also, a variety of types of conveyors can be utilised in various embodiments depending on the type or nature of materials being transported by a conveyor. Various types of conveyors are well known in the industry and can be utilised in various configurations to facilitate embodiments of the present invention. As a specific example, conveyor belts may be cut-proof and oil-proof synthetic rubber with a thickness ranging from, for example, 5 mm to 15 mm. In a further specific embodiment, the density-based sorting means may be a horizontal air-sieve system with adjustable conduction-plate's and an air-sieve blowmouth. Blade rotors can be provided associated with a rotary valve to provide suction. It is also possible to provide container press units to compact any of the sorted or extracted types of materials.

The present invention is especially suited to recovery of organic-rich fractions (typically 30 to 65% organic content) that may otherwise enter landfill due to inefficiencies in prior art systems. Organic-rich fractions, for example second undersize-midsize combined fraction (426), can be introduced to percolators and associated equipment, including anaerobic digesters, sand separators, sludge screens and/or water denitrifiers. For example, these types of apparatus can be provided by the ISKA percolation technology provided by the German company ISKA GmbH.

Thus, there has been provided in accordance with the present invention a municipal solid waste sorting system and method.

The invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although the preferred embodiment has been described in detail, it should be understood that various changes, substitutions, and alterations can be made by one of ordinary skill in the art without departing from the scope of the present invention.

1.-27. (canceled)

28. A method of sorting municipal solid waste into types of materials, the method comprising:
sorting the municipal solid waste based on size into an oversize fraction, a midsize fraction, and an undersize fraction;
using at least manual-based, density-based, and metal-based sorting to produce a partial oversize fraction, a first partial midsize fraction, and a second partial midsize fraction;
combining the partial oversize fraction and the first partial midsize fraction to produce an oversize-midsize combined fraction;
combining the undersize fraction and the second partial midsize fraction to produce an undersize-midsize combined fraction; and
using at least one of manual-based, density-based, size-based, and metal-based sorting to sort the oversize-midsize combined and the undersize-midsize combined fractions into the types of materials.

29. The method of claim 28, wherein sorting the midsize fraction to produce the partial oversize fraction comprises manual extracting and then density-based extracting.

30. The method of claim 28, wherein sorting the midsize fraction to produce the first partial midsize fraction and the second partial midsize fraction comprises density-based extracting, then metal-based extracting, then manual extracting, and then size-based sorting.

31. A method of sorting mixed solid waste into types of materials, the method comprising:
automatically sorting the mixed solid waste based on size into an oversize fraction, a midsize fraction, and an undersize fraction;
sorting the oversize fraction into types of materials, sorting the oversize fraction comprising:
manually sorting the oversize fraction to extract at least a portion of the oversize fraction and to leave a residue of the oversize fraction; and
sorting the residue of the oversize fraction based on density to produce a first oversize fraction of lower density materials and a second oversize fraction of higher density materials;
sorting the midsize fraction into types of materials, sorting the midsize fraction comprising:
sorting the midsize fraction based on density to produce a first midsize fraction of lower density materials and a second midsize fraction of higher density materials;
metal-based sorting the second midsize fraction to produce a third midsize fraction of metallic-rich materials and a fourth midsize fraction of non-metallic-rich materials; and
automatically sorting at least part of the fourth midsize fraction based on size into a fifth midsize fraction of smaller sized materials and a sixth midsize fraction of larger sized materials;
combining the second oversize fraction and the sixth midsize fraction to produce a combined oversize-midsize fraction;
manually sorting the combined oversize-midsize fraction to extract at least a portion of the combined oversize-midsize fraction and to leave a reside of the combined oversize-midsize fraction;
metal-based sorting the residue of the combined oversize-midsize fraction to produce a first oversize-midsize combined fraction of non-metallic-rich materials and a second oversize-midsize combined fraction of metallic-rich materials;
combining the undersize fraction and the fifth midsize fraction to produce a combined undersize-midsize fraction; and
metal-based sorting the combined undersize-midsize fraction to produce a first undersize-midsize combined fraction of metallic-rich materials and a second undersize-midsize combined fraction of non-metallic-rich materials.

32. The method of claim 31, wherein manually sorting the oversize fraction comprises extracting at least bulky or substantially large materials.

33. The method of claim 31, further comprising manually sorting to extract at least glass materials.

34. The method of claim 31, wherein manually sorting the combined oversize-midsize fraction comprises extracting at least paper or plastic materials.

35. The method of claim 31, wherein the density-based sortings are used to extract film plastic materials.

36. The method of claim 31, wherein the metal-based sortings comprise extracting at least one of or both of ferrous and non-ferrous metal materials.

37. The method of claim 31, wherein the second undersize-midsize combined fraction comprises organic-rich materials.

38. The method of claim 31, further comprising automatically sorting the first oversize-midsize combined fraction based on size to produce a third oversize-midsize combined fraction and at least a fourth oversize-midsize combined fraction.

39. The method of claim 38, wherein at least the fourth oversize-midsize combined fraction comprises organic-rich materials.

40. A system for sorting municipal solid waste into types of materials, the system comprising:
first size-based sorting means for sorting the municipal solid waste into an oversize fraction, a midsize fraction, and an undersize fraction based on size;
manual-based, density-based, second size-based, and metal-based sorting means to obtain a partial oversize fraction, a first partial midsize fraction, and a second partial midsize fraction;
means to combine the partial oversize fraction and the first partial midsize fraction to produce an oversize-midsize combined fraction;
means to combine the undersize fraction and the second partial midsize fraction to produce an undersize-midsize combined fraction; and
further manual-based, density-based, size-based, or metal-based sorting means for further sorting the oversize-midsize combined fraction and the undersize-midsize combined fraction into the types of materials.

41. The system of claim 40, wherein the partial oversize fraction comprises a residue of manual-based extraction and subsequent density-based extraction.

42. The system of claim 40, wherein the first partial midsize fraction and the second partial midsize fraction comprise residues of density-based extraction, then metal-based extraction, then manual extraction, and then size-based sorting.

43. A system for sorting mixed solid waste into types of materials, the system including:
a first size-based sorting means for sorting the mixed solid waste into an oversize fraction, a midsize fraction, and an undersize fraction based on size;
a first sorting station for sorting the oversize fraction into the types of materials by extracting at least part of the oversize fraction;
a first density-based sorting means for sorting the residue of the first sorting station to produce a first oversize fraction of lower density materials and a second oversize fraction of higher density materials;
a second density-based sorting means for sorting the midsize fraction into the types of materials to produce a first midsize fraction of lower density materials and a second midsize fraction of higher density materials;
a first metal-based sorting means for sorting the second midsize fraction to produce a third midsize fraction of metallic-rich materials and a fourth midsize fraction of non-metallic-rich materials;
a second size-based sorting means for sorting at least part of the fourth midsize fraction into a fifth midsize fraction of smaller sized materials and a sixth midsize fraction of larger sized materials;
first means to combine the second oversize fraction and the sixth midsize fraction into a combined oversize-midsize fraction;
a second sorting station for extracting at least part of the combined oversize-midsize fraction;
a second metal-based sorting means for sorting a residue of the second sorting station to produce a first oversize-midsize combined fraction of non-metallic-rich materials and a second oversize-midsize combined fraction of metallic-rich materials;
second means to combine the undersize fraction and the fifth midsize fraction; and
a third metal-based sorting means for sorting the undersize-midsize combined fraction to produce a first undersize-midsize combined fraction of metallic-rich materials and a second undersize-midsize combined fraction of non-metallic-rich materials.

44. The system of claim 43, wherein the first and second size-based sorting means comprise trommels.

45. The system of claim 43, wherein the first and second sorting stations comprise chutes to facilitate extraction of the types of materials.

46. The system of claim 43, wherein the first and second density-based sorting means comprise at least one of windsifters and bounce adherence conveyors.

47. The system of claim 43, wherein the first, second, and third metal-based sorting means comprise at least one of magnetic separators and non-ferrous metal separators.

48. The system of claim 47, wherein the magnetic separators comprise rotary belt magnetic separators.

49. The system of claim 43, wherein the first, second, and third metal-based sorting means utilize magnetic, electromagnetic, conductivity, or insulating properties of materials.

50. The system of claim 43, wherein the first and second means to combine fractions comprise a common conveyor belt for deposition of the fractions.

51. The system of claim 43, further comprising a products baler to package the types of materials.

52. The system of claim 43, further comprising a bio-organic processor to process the second undersize-midsize combined fraction.

53. The system of claim 43, further comprising a third size-based sorting means for sorting the second oversize-midsize combined fraction to produce a third oversize-midsize combined fraction and at least a fourth oversize-midsize combined fraction.

54. The system of claim 43, wherein at least one of the first and second sorting stations comprises an automated sorting station.

55. The system of claim 43, wherein at least one of the first and second sorting stations comprises a manual sorting station.
